(19) United States
(12) Patent Application Publication
(10) Pub. No.: US 2010/0127627 A1
(43) Pub. Date: May 27, 2010

(54) LIGHT-EMITTING MEDICAL DEVICES HAVING PROTECTIONS AGAINST UNINTENDED LIGHT EXPOSURE

(75) Inventors: Qichao Zhu, Burnaby (CA); Phaik Sun Koay, Vancouver (CA); Luya Li, Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: URODYNAMIX TECHNOLOGIES LTD., Vancouver, BC (CA)

(21) Appl. No.: 12/598,422

(22) PCT Filed: May 1, 2008
(86) PCT No.: PCT/CA08/00823

§ 371 Date: Oct. 30, 2009

Related U.S. Application Data
(60) Provisional application No. 60/915,401, filed on May 1, 2007.

(51) Int. Cl. H05B 37/02

(52) U.S. Cl. 315/149; 315/362

(57) ABSTRACT

Apparatus and methods are provided for guarding against unintended exposure to light from a light-emitting device used to direct light to a subject for detection by a light detector. A sensor signal indicative of light detected by the light detector is sampled. An inhibition signal for inhibiting emission of light from the light-emitting device is generated, based at least in part on whether emitted light is expected from the light-emitting device and the comparison of the sampled sensor signal value to a threshold value. The light-emitting device may be monitored for continuous wave operation. A mechanical interlock may be provided having a guard moveable between closed and open positions respectively to cover and expose a port of the light-emitting device.

### CROSS-REFERENCE TO RELATED APPLICATION

This application claims priority from U.S. patent application No. 60/915,401 filed 1 May 2007 and entitled LIGHT-EMITTING MEDICAL DEVICES HAVING PROTECTIONS AGAINST UNINTENDED LIGHT EXPOSURE. For purposes of the United States of America, this application claims the benefit under 35 U.S.C. §119 of U.S. patent application No. 60/915,401 filed 1 May 2007 and entitled LIGHT-EMITTING MEDICAL DEVICES HAVING PROTECTIONS AGAINST UNINTENDED LIGHT EXPOSURE which is hereby incorporated herein by reference.

### TECHNICAL FIELD

The invention relates to medical devices and in particular to medical devices that emit light for diagnostic or treatment purposes. Some specific embodiments of the invention provide apparatus and methods for protecting against unintended light exposure from near infrared spectrometry (NIRS) devices.

### BACKGROUND

Various medical devices emit light. Light includes visible light and invisible light. Invisible light includes ultraviolet light and infrared light. The light may be intended for a diagnostic or therapeutic purpose. Depending upon the application, the light may comprise visible light, invisible light or some combination of visible and invisible light.

An example of a light-emitting medical device is a NIRS system. Near Infrared Spectroscopy (“NIRS”) is a technique which involves emitting near infrared (“NIR”) light and receiving the NIR light after it has passed through a tissue or other medium of interest. NIRS can be applied to study and monitor biochemical compounds in the body. Emitted NIR light penetrates skin and other tissues and some of it is absorbed by biochemical compounds which have an absorption spectrum in the NIR region. NIR light which is not absorbed is scattered. Each biochemical compound has a different absorption spectrum. It is possible to estimate the concentration of biochemical compounds in the tissues by measuring characteristics of NIR light that has been detected after it has passed through the tissues.

Light can be dangerous to the eyes. Intense invisible light is particularly dangerous because the eye of an observer can receive damaging exposure to the intense light without realizing that damage is occurring.

There is a need for practical light-emitting medical devices that can prevent unintended light exposure.

### BRIEF DESCRIPTION OF THE DRAWINGS

In drawings which illustrate non-limiting embodiments of the invention,

FIG. 1 is a block diagram of a medical apparatus according to a generalized example embodiment of the invention.

FIG. 2 is a partially schematic diagram showing a light guard and mechanical interlock in apparatus according to an example embodiment of the invention.

FIG. 3 is a block diagram of a circuit that may be used to implement a multi-trigger light output inhibiting arrangement.

FIG. 4 is a block diagram showing an example circuit for monitoring both light output and electrical current.

FIG. 5 is a flow chart illustrating a method that is performed in some embodiments of the invention.

FIG. 6 is a flow chart illustrating a method that is performed in some embodiments of the invention.

FIG. 7 is a block diagram of a medical apparatus according to another generalized example embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The following description describes a medical device that has three different systems for preventing unintended exposure to radiation. These include a mechanical interlock, a hardware safety shut off, and firmware routines that interact with the hardware to prevent unintended exposure. These systems may be provided individually or in any suitable combinations. The invention also provides methods for preventing unintended exposure to light.

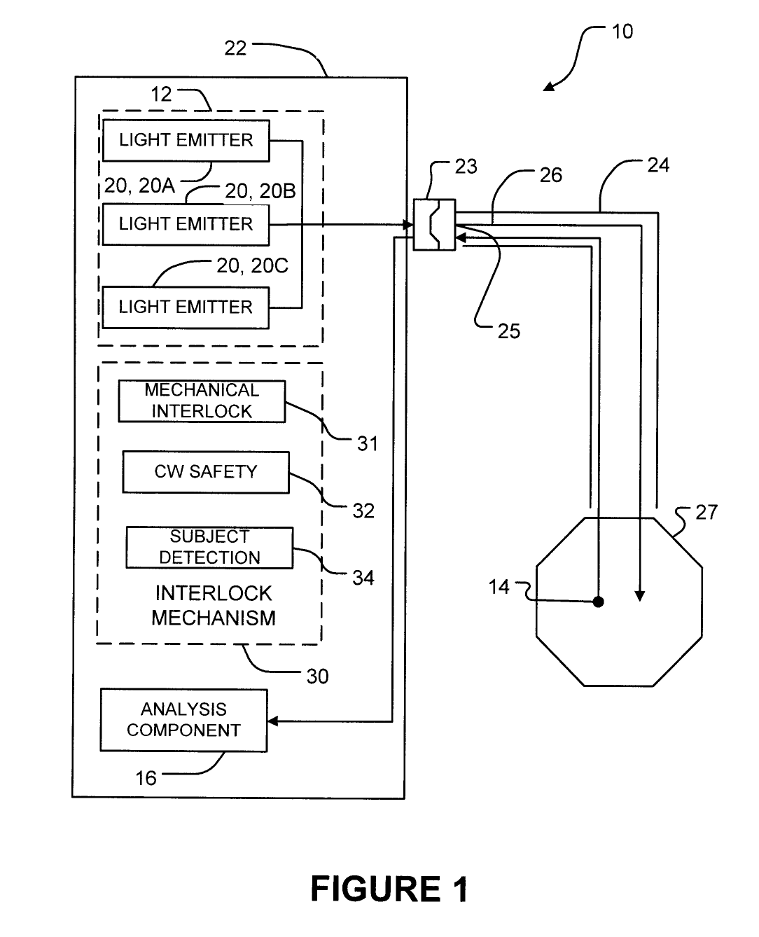

FIG. 1 shows an apparatus 10 according to an example embodiment of the invention. Apparatus 10 includes a light source 12 that emits light toward tissues of a subject, a light detector 14 that receives some of the light that has passed through the subject's tissues and an analysis component 16 that analyzes the detected light to obtain information about the subject's tissues.

For example, light source 12 may emit infrared light, and analysis component 16 may evaluate concentrations (or changes in concentration) of one or more biological compounds in the subject's tissues by analyzing detected light. In such embodiments, apparatus 10 may employ NIRS to evaluate concentrations of one or more compounds in tissues of a subject.

In the illustrated embodiment, light source 12 comprises one or more light emitters 20 (e.g. light emitters 20A, 20B, 20C) within a housing 22. Light emitters 20 deliver light to one or more corresponding ports 23. Cables 24 have couplings 25 that engage ports 23. When a coupling 25 of a cable 24 is connected to a corresponding port 23, a light path is established from a corresponding one or more of light emitters 20 to an optical fiber 26 within cable 24. Optical fiber 26 extends to a patch 27 which is intended to be placed against the skin of a subject when apparatus 10 is in use. In some embodiments, light detector 14 detects light received at patch 27. In such embodiments, light detector 14 may be on or mounted to patch 27 or may receive light that is collected at patch 27 and directed to detector 14 by way of a suitable optical fiber (e.g. a receiver cable).

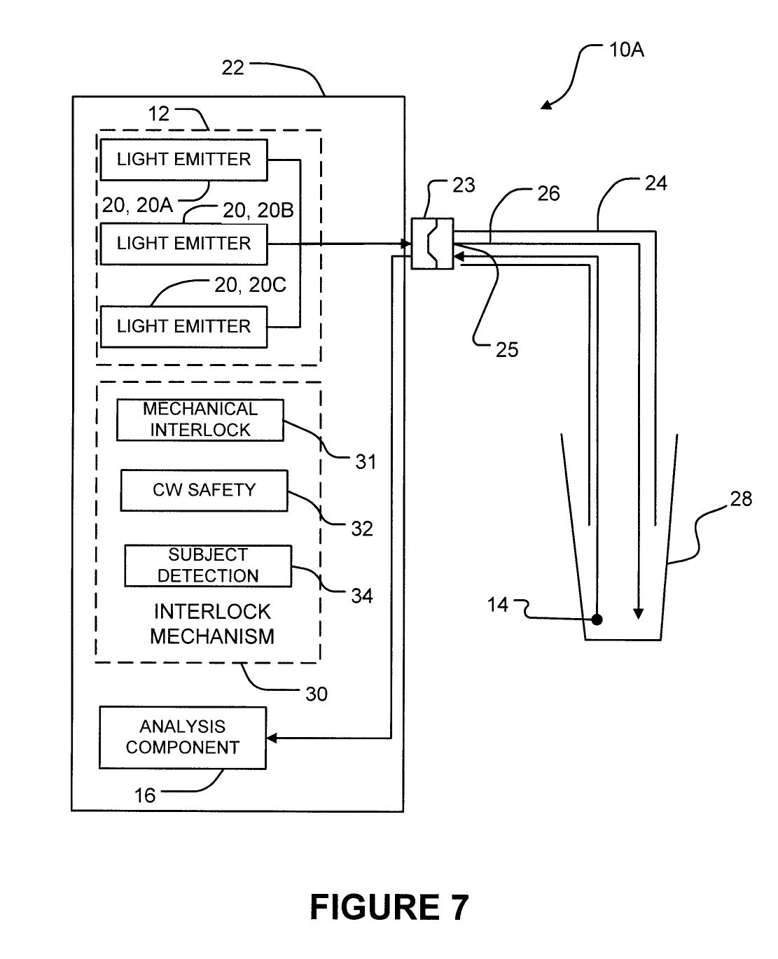

In other embodiments, optical fiber 26 carries light to a location on or in a catheter or other instrument inserted in the subject's body for diagnosis or medical treatment or surgery. For example, FIG. 7 shows an apparatus 10A in which optical fiber 26 extends into catheter 28 to carry light toward a tip of catheter 28. Light detector 14 may be located at or near a tip of catheter 28 as illustrated, or at some other location on catheter 28. Apparatus 10A has many features in common with apparatus 10, and the same reference numerals are used in FIGS. 1 and 7 to label the common features.

As seen in FIGS. 1 and 7, an interlock mechanism 30 prevents light emitters 20 from being energized to emit high intensity light in certain cases where such high-intensity light could escape to cause harm. Some example interlock mechanisms that may be applied as an interlock mechanism 30 are described below.

Interlock mechanism 30 may be triggered to disable light emitters 20 upon various conditions including, for example, one or more of:
A port 23 does not have a coupling 25 properly plugged in to it.
A shield (not shown in FIG. 1) is not disposed to block any light escaping from ports 23.
   A mechanical interlock 31 may be provided to invoke interlock mechanism 30 if one or more of these conditions exist.

A continuous wave (CW) safety mechanism 32 determines whether the light being output by light emitters 20 is pulsed or continuous wave. If the light being output is continuous wave (or, in some embodiments, if the light being output has a time-averaged intensity in excess of a threshold value) then light emitters 20 are automatically disabled. Some example mechanisms that may be applied as CW safety mechanism 32 are described below.

A subject detection system 34 determines whether or not patch 27 is against the skin of a subject. If patch 27 is not against the skin of a subject then there is a possibility that light being emitted at patch 27 could enter someone's eye and cause eye damage. Subject detection system 34 may detect one or more of:
Signals at light detector 14 that are indicative of stray light being received by light detector 14;
Light detector 14 is not receiving light emitted by optical fiber 26.

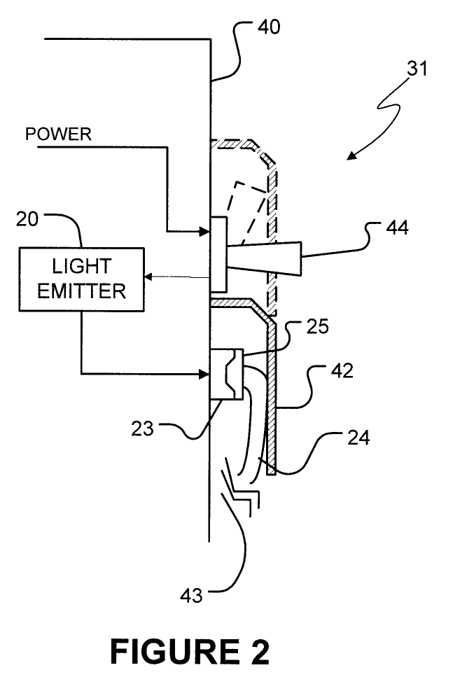

FIG. 2 shows a mechanical interlock 31 according to an example embodiment of the invention. Port(s) 23 are provided in a front panel 40 of housing 22. Mechanical interlock 31 comprises a guard 42 that is movable between a “closed” position in which guard 42 blocks direct viewing of port(s) 23 and an “open” position in which port(s) 23 are exposed so that couplings 25 can be coupled to or disconnected from port(s) 23. Guard 42 is opaque (or at least opaque enough to attenuate to a safe level) the light from light emitter(s) 20.

When guard 42 is in its closed position, a slot or other opening 43 is provided to allow cables 24 to pass out from behind guard 42. The slot or other opening is not in line with ports 23 such that any light that emerges from port(s) 23 cannot shine straight through the slot or other opening.

When guard 42 is in its open position, light emitter(s) 20 are inhibited from emitting light. In the illustrated embodiment, a power switch 44 is located such that it blocks guard 42 from being moved to its open position when power switch 44 is in an ON position (as shown in solid outline in FIG. 2), permitting light emitter(s) 20 to be energized. When guard 42 is in its open position it blocks access to power switch 44 such that power switch 44 must be in an OFF position (as shown in dashed outline in FIG. 2) and cannot be turned to the ON position.

In other embodiments, power switch 44 is located such that when it is in the ON position and guard 42 is in the closed position, movement of guard 42 toward the open position causes guard 42 to engage with and move power switch 44 from the ON position to the OFF position. This ensures that power to light emitters 20 is shut off as soon as an operator moves guard 42 from its closed position to expose ports 23.

Guard 42 may comprise:
a sliding cover which slides between the open and closed positions (as shown in FIG. 2);
a pivoting cover which pivots between the open and closed positions;
a separate cover that may be attached to cover port(s) 23; or
a combination of two or more of the above.

Power switch 44 may incorporate a lever, a push button, a toggle, a rocker switch or any suitable mechanism which switches power on and off, and engages with guard 42 to prevent unintended exposure of light emerging from ports 23.

A circuit that inhibits operation of light emitters 20 may also, or in the alternative, be operated in response to micro-switches or other switches which assume a state such that power is shut off or the inhibition signal is present when guard 42 is its open position (and/or guard 42 is not in its closed position).

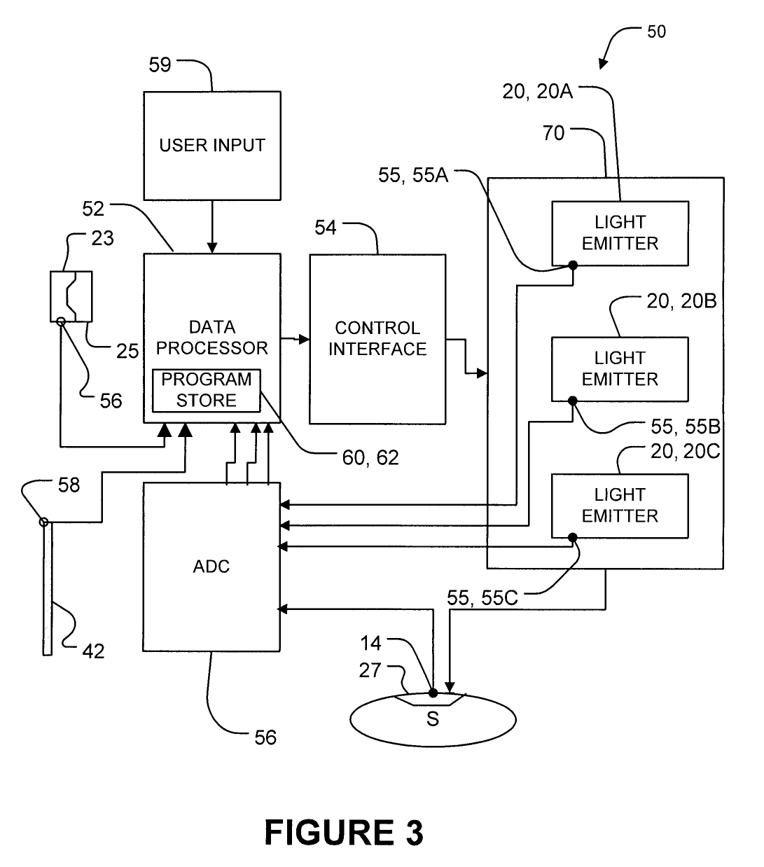

FIG. 3 shows a circuit 50 that may be used to implement a multi-trigger light output inhibiting arrangement in apparatus according to embodiments of the invention. Circuit 50 comprises a data processor 52 such as a programmable controller, a digital signal processor (DSP), a microprocessor, or the like. Data processor 52 controls light emitters 20 by way of a control interface 54. Light emitters 20 emit light only when they are enabled by control interface 54.

In the illustrated embodiment, data processor 52 receives an input from a light detector 55 that detects light emitted by a light emitter 20. In the illustrated embodiment, there are three light emitters 20A, 20B and 20C (collectively light emitters 20) and three corresponding light detectors 55A, 55B, and 55C. When they are energized, light emitters 20A, 20B and 20C emit light at different wavelengths. Some of the light is detected by light detectors 55A, 55B and 55C. Light emitters 20 may be lasers, and are typically solid-state lasers such as laser diodes.

Outputs from light detectors 55 are sampled by one or more analog-to-digital converters (ADCs) 56 to yield digital signals that indicate the amount of light emitted by each light emitter 20. The digital signals are provided to data processor 52. In some embodiments, one or more ADCs 56 are integrated with data processor 52. In other embodiments, ADCs are provided separately or light detectors 55 are of a type that provides a digital output.

Having light detectors 55 that monitor the light emitted by emitters 20 before the light passes through tissues of a subject is optional. Some embodiments lack such light detectors. In such embodiments information regarding the intensity of light emitted by light emitters 20 can be obtained from the intensity of light detected by light detector 14.

The signals from light detectors 55 as well as any other signals may be subjected to suitable amplification, filtering, combinations thereof, or other suitable signal conditioning steps either in the digital or analog domain before those signals are processed by data processor 52. The extent to which such signal conditioning is desirable or necessary in any particular embodiment is a matter of design choice.

Data processor 52 also receives digitized signals from light detector 14. Light detector 14 is intended to detect light that has passed through tissues of a subject S. If light detector 14 receives light collected at a location on patch 27 then light detector 14 may also detect stray light if patch 27 is not properly against the skin of subject S.

Data processor 52 also receives signals from one or more switches or circuits 56 that detect whether couplings 25 are properly engaged with ports 23 and signals from one or more switches or circuits 58 that detect whether guard 42 is in its closed position.

Data processor 52 also receives signals from one or more user controls 59 (which may comprise switches, inputs made by way of a graphical or other computer interface, or the like) which indicate whether a user, such as a physician or medical technician desires to operate light emitters 20.

Data processor 52 executes instructions 60 in a program store 62 (which may be, but is not necessarily integrated with data processor 52). Instructions 60 cause data processor 52 to generate a signal that permits and/or causes interface 54 to operate light emitters 20 to emit light when a set of one or more criteria is satisfied.

The set of criteria may, for example, permit light emitters 20 to emit light only if the following conditions are all met:
User controls 59 indicates that a user wishes to operate the apparatus in a mode that requires light emitters 20 to be operational; AND
Switches or circuits 58 indicate that guard 42 is in its closed position; AND
Switches or circuits 56 indicate that couplings 25 are properly connected to ports 23; AND
The signal output from light detector 14 does not contain more than a threshold amount of noise (which could indicate exposure to ambient light); AND
The signal output from light detector 14 correlates with the operation of light emitters 20 (i.e. light detector 14 is detecting signals when one or more of light emitters 20 is emitting light and is not detecting significant amounts of light at other times); AND
The signal outputs from light detectors 55 indicates that light emitters 20 are each operating in a desired time sequence (For example, if light emitters 20 are intended to operate in a pulsed mode, this condition may require one or more of: the outputs of light detectors 55 have a corresponding pulsed waveform; at least a certain fraction of samples of the outputs of light detectors 55 is less than a threshold; or the like); AND
The signal outputs from light detectors 55 do not exceed threshold values.
   In the above, AND represents the logical AND operation.

It is not mandatory that data processor 52 check all of these conditions. Instructions 60 may cause data processor 52 to check:
one or more of the above conditions; or
any combination of one or more of the above conditions with one or more other conditions.
   If one or more of the conditions that data processor 52 checks is not satisfied then data processor 52 inhibits interface 54 so that light emitters 20 cannot operate.

Some embodiments of the invention provide a circuit that independently verifies that the light being delivered by light emitters 20 meets certain emission criteria and inhibits the operation of light emitters 20 otherwise. FIG. 3 shows a monitoring circuit 70 that has this function. Monitoring circuit 70 may monitor light emitters 20 to ensure one or more of the following:
light emitters 20 are emitting pulsed light (as opposed to continuous wave light);
the outputs of light emitters 20 do not exceed a threshold; or the like.
   Monitoring circuit may comprise one or more light detectors (such as light detectors 55) that detect light emitted by light emitters 20 and/or may monitor the electrical supply (current and/or voltage) delivered to light emitters 20.

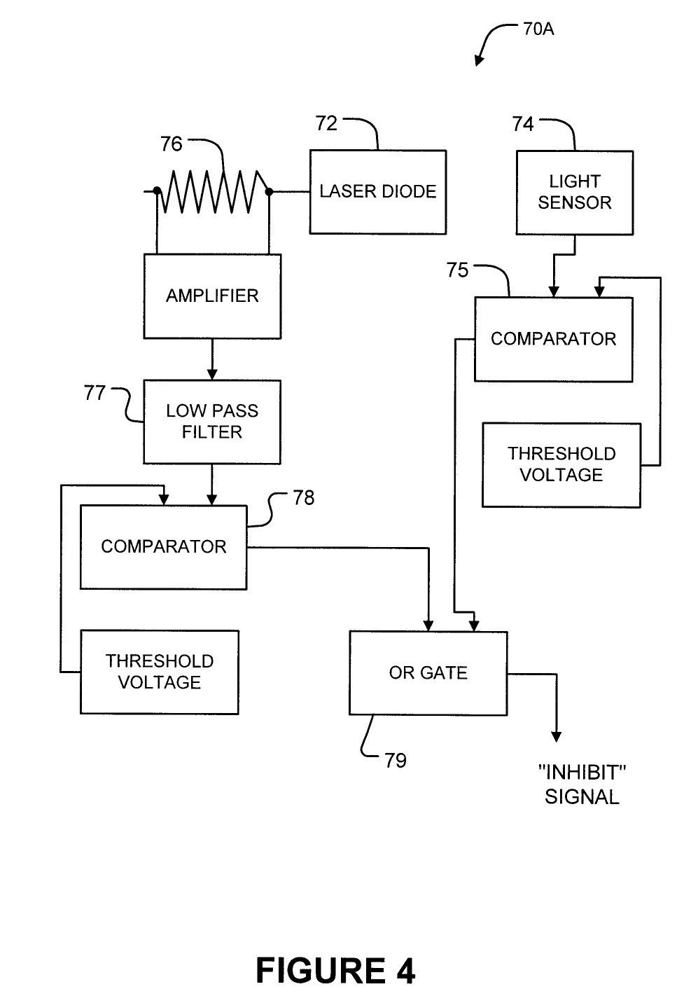

FIG. 4 shows an example monitoring circuit 70A which monitors both light output and electrical current supplied to a laser diode 72. Circuit 70A has been simplified for purposes of illustration. Conventional elements such as power supplies and the like have been omitted for clarity. In any particular embodiment additional signal conditioning circuitry may be necessary or desirable to achieve good results. Such additional circuitry is known to electrical engineers and others skilled in the field and is not shown in FIG. 4 to avoid obscuring the invention.

In circuit 70A, a fraction of the light emitted by laser diode 72 is intercepted by a light sensor detector 74 that generates an output signal proportional to the intensity of the detected light. This output signal is provided to a comparator 75 that compares the signal to a threshold voltage. The electrical current driving laser diode 72 is monitored by measuring a voltage drop across a series-connected resistor 76. A signal indicating the voltage drop is passed through a low-pass filter 77. The output from low-pass filter 77 is monitored by a comparator 78. Outputs from comparators 75 and 78 are combined at OR gate 79 to provide an inhibition signal at the output of OR gate 79.

Circuit 70A may provide circuit elements for detecting CW operation instead of or in addition to a low-pass filter 77. For example, an integrator configured to integrate the voltage drop signal over an integral number of periods of the driving signal for laser diode 72 or a timer configured to time pulses in the driving current for laser diode 72 could be used as alternative means for detecting CW operation of laser diode 72.

In other embodiments, CW operation may be monitored by sampling the signal detected by light detector 14 or light detectors 55 at a frequency greater than the light pulse frequency. If light emitters 20 were emitting pulses of light, it is expected that some of the sampled signals would indicate that there is no light output (e.g. these sampled signals would be below a threshold value). The absence of any sampled signals below a threshold value may be an indication of CW operation of light emitters 20.

The inhibition signal is applied to inhibit light emitters 20 from operating if either the peak light output from a light emitter 20 exceeds a threshold or if a light emitter 20 is operating in a continuous wave mode (or is delivering significantly longer-than-intended pulses). The inhibition signal preferably controls a switch or relay that is independent of the state of interface 54 such that inhibition circuit 70 can shut off light emitters 20 even if interface 54 fails. In the alternative, or in addition, circuit 70 may deliver the inhibition signal to interface 54.

In preferred embodiments, light-emitting apparatus has multiple redundant systems for preventing damaging exposure to light including two or more of, and preferably all three of:
A mechanical interlock that prevents operation of a switch that must be switched on to supply power to at least the part of the apparatus that powers light emitters 20;
An electronic circuit 70 that monitors at least electrical current being supplied to light emitters 20 and shuts off the current supplied to light emitters 20 if the electronic circuit detects that one or more of light emitters 20 is operating in a continuous wave mode (or in a mode that does not match a pattern being monitored for by the circuit); and,
A data processor that monitors one or more inputs and inhibits the operation of light emitters 20 by way of an interface 54 if any of the conditions fails to be satisfied.

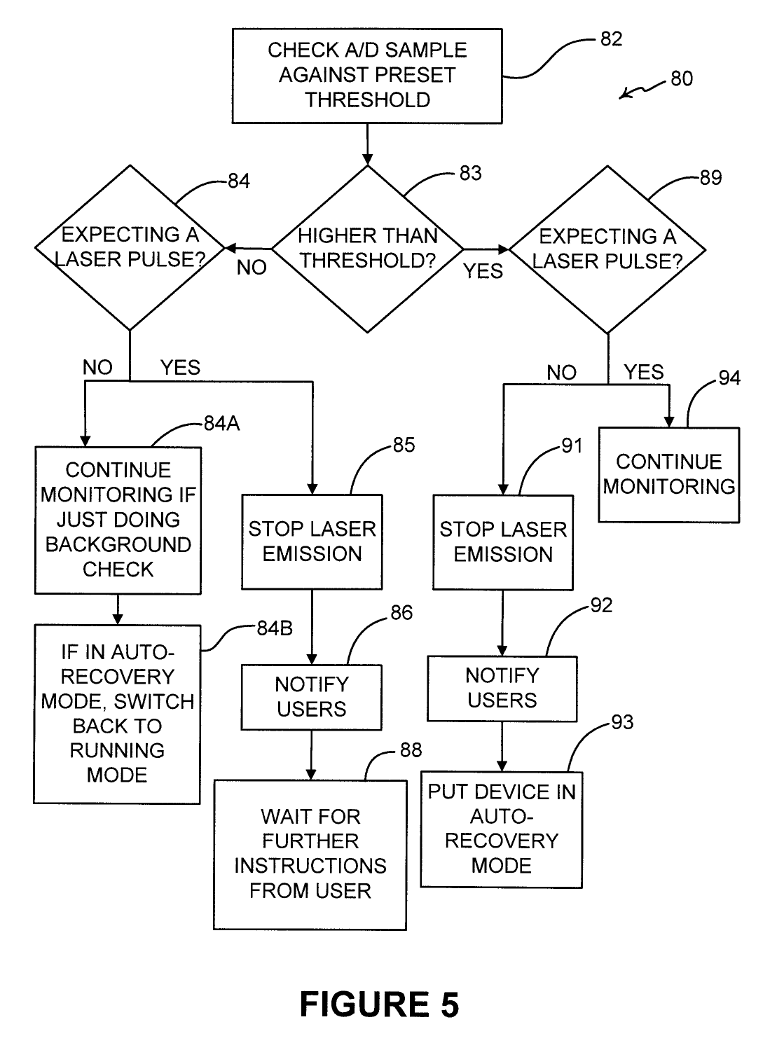

FIG. 5 is a flow chart for a decision-making method 80 that may be implemented in a processor or logic circuits of a light-emitting apparatus. In block 82, method 80 samples a signal detected at light detector 14 at spaced apart times. Where light output by light emitters 20 is pulsed, the times are spaced more closely together than the duration of light pulses so that light pulses will not be missed. For example, light emitters 20 are controlled to emit light in pulses having durations of 3 to 5 microseconds (for example about 4 microseconds) in some embodiments. In such embodiments, the output of light detector 14 may be sampled periodically with an interval between samples that is shorter than the pulse length (for example less than 3 microseconds).

In block 83, method 80 compares the sampled signal value to a threshold (the threshold is selected to be indicative of a signal level that could correspond to a valid detected pulse). Where the sampled signal value is less than the threshold, method 80 branches to block 84.

In block 84 method 80 determines whether or not a light pulse is expected to be detected at detector 14 (i.e. whether an emitter 20 should have been emitting light at the time of taking the sample). This may be determined by receiving a signal from emitter 20 indicative of whether emitter 20 is operating to emit light (e.g. the signal may indicate that power supply to emitter 20 is switched ON, etc.). In the event of a NO decision at block 84 then method 80 returns to block 82 as indicated at block 84A. If the apparatus is in auto-recovery mode (as described below) then the apparatus is returned to its normal operating mode in block 84B.

In the event of a YES decision at block 84 (indicating that a pulse was not detected but ought to have been detected) method 80 proceeds to block 85 which inhibits operation of light emitters 20 and block 86 which generates a message (such as a display, warning light, sound, etc.) indicating to users what has occurred. In block 88 method 80 waits for further instructions from a user (for example, method 80 may wait while the user checks the application of patch 27 and then resets the apparatus).

If block 83 determines that the sampled signal has a value exceeding the threshold then method 80 proceeds to block 89. It is a design choice whether method 80 branches to block 85 or 89 when the sampled value is equal to the threshold. In block 89 method 80 determines whether or not a light pulse is expected to be detected at detector 14.

In the event of a YES decision at block 89 then method 80 returns to block 82 as indicated at block 94. In the event of a NO decision at block 89 (indicating that light emitters 20 could be emitting light when they are not intended to be on) method 80 proceeds to block 91 which inhibits operation of light emitters 20 and block 92 which generates a message (such as a display, warning light, sound, etc.) indicating to users what has occurred. Method 80 then proceeds to block 93. In block 93, method 80 may wait for further user input (such as at block 88) to resume operation of light emitters 20 or to perform some other action.

In some embodiments, block 93 may invoke an auto-recovery mode (or auto-discovery mode). In such embodiments, while auto-recovery mode is invoked, operation of light emitters 20 is inhibited and the signal at light detector 14 is monitored for a pattern that indicates that light detector 14 is shielded from ambient light (e.g. that patch 27 is properly in place on a subject in the case that light detector 14 is on patch 27 or senses light collected at patch 27). The pattern may include observed characteristics or trends (e.g. above normal variations, or signals indicative of ambient light noise) in the sampled signal values over time.

In some embodiments, for each value of the sampled signal detected at light detector 14, a flag may be set corresponding to certain conditions (e.g. the sampled signal value is higher or lower than a threshold, and emitted light is or is not expected at the time of sampling). In some embodiments, a first flag may be set if the sampled signal value is lower than a threshold and a light pulse is expected; a second flag may be set if the sampled signal value is lower than a threshold, a light pulse is not expected and the device is operating in auto-recovery mode; or a third flag may be set if the sampled signal value is above a threshold and no light pulse is expected. A series of bits (or a bit string) may be generated to maintain a record of flags which are set for each sampled signal value. Patterns in the series of bits may be used to identify the existence of a condition. For example, if the first flag is set for numerous sampled signal values over a time period (indicating that a light pulse is expected but the detected light is below a threshold), this may be a pattern indicative of broken or disconnected optical fibers, malfunctioning light emitters or failure of the light detector to receive light or transmit a signal. Similarly, if the third flag is set for numerous sampled signal values over a time period (indicating that no light pulse is expected but the detected light is above a threshold), this may be a pattern indicative of light leaking to the light detector, a loose or detached patch or light detector not being shielded from ambient light.

Instead of generating a series of bits to record the flags which are set, as described above, other values, such as the sampled sensor signal values obtained by A/D sampling of the signal detected at light detector 14, may be recorded. Patterns in the recorded sensor signal values may then be identified and compared with predetermined pattern conditions.

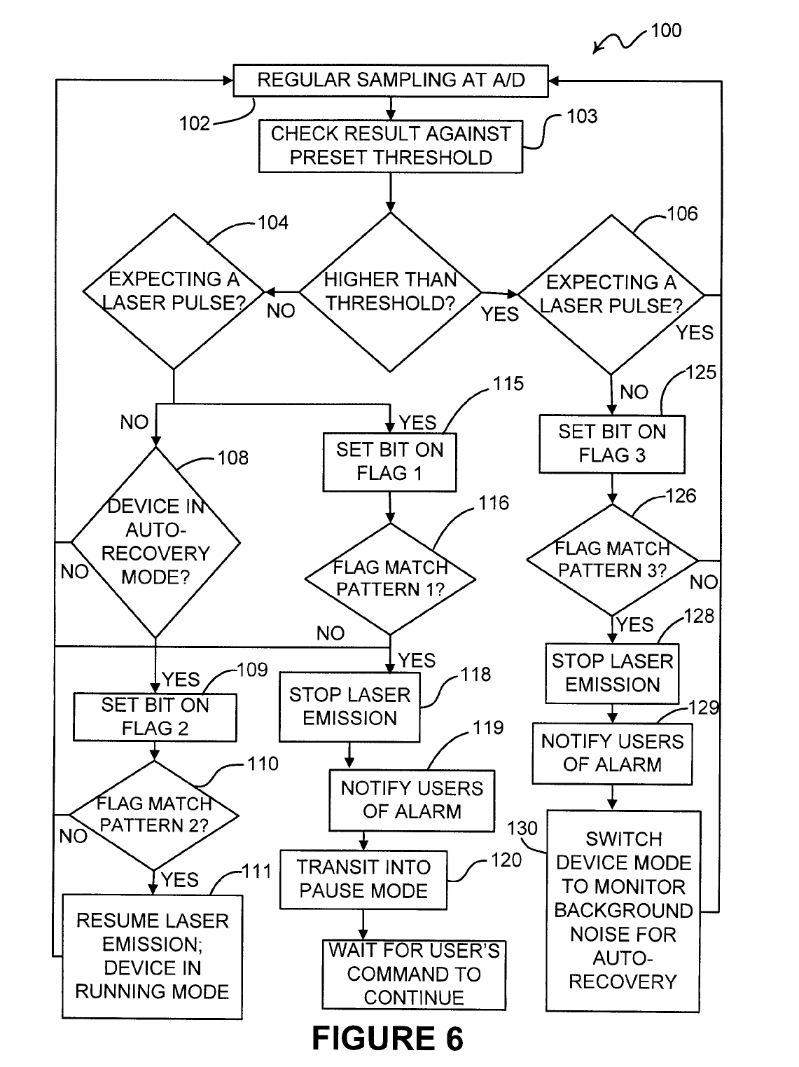

FIG. 6 is a flow chart for a decision-making method 100 that may be implemented in a processor or logic circuits of a light-emitting apparatus. Method 100 may be performed together with method 80 but may also be performed independently of method 80.

In block 102, method 100 samples a signal detected at light detector 14 at spaced apart times. In block 103, method 100 compares the sampled signal value to a threshold (the threshold is selected to be indicative of a signal level that could correspond to a valid detected pulse). Where the sampled signal value is less than the threshold, method 100 branches to block 104. Where the sampled signal value is greater than the threshold, method 100 branches to block 106.

Blocks 104 and 106 each determine whether or not a pulse is expected to be detected at detector 14. In a case where method 80 and 100 are being performed together, blocks 82, 83, 84 and 89 may be shared between methods 80 and 100 and may provide blocks 102, 103, 104 and 106 of method 100.

In the event of a NO result in block 104 (i.e. no pulse is expected at detector 14), method 100 proceeds to block 108 which determines whether the auto-recovery mode has been invoked. If not, method 100 returns to block 102. If auto-recovery mode has been invoked then method 100 proceeds to block 109 which sets a bit of a bit string (FLAG2) and then proceeds to block 110.

In block 110, bit string FLAG2 is compared to a predetermined pattern, PATTERN2, that would be expected for the case that light detector 14 is shielded from ambient light and patch 27 is properly in place on a subject. If PATTERN2 is not matched by bit string FLAG2, method 100 returns to block 102. Otherwise, at block 111, the apparatus is placed into its normal running mode (i.e. the operation of light emitters 20 is not inhibited and light emitters 20 are controlled to emit light in a desired operational mode—such as a desired pattern of pulses). Method 100 then returns to block 102.

In the event of a YES result in block 104 (i.e. a pulse is expected at detector 14), then in block 115 a bit is set in a bit string (FLAG1) and method 100 proceeds to block 116. In block 116, bit string FLAG1 is compared to a predetermined pattern, PATTERN1, that would be expected for the case that there is a broken or disconnected optical fiber 26, light detector 14 is not receiving light or is not transmitting a signal (e.g. broken or disconnected receiver cables), or light emitters 20 are not emitting light (e.g. malfunctioning lasers). If bit string FLAG1 does not match PATTERN1 (NO result in block 116) then method 100 returns to block 102. Otherwise, method 100 inhibits light emitters 20 in block 118, and generates a message (such as a display, warning light, sound, etc.) indicating to users what has occurred in block 119. In block 120, method 100 pauses and waits for a user input before proceeding. For example, in block 120 method 100 may wait while the user reconnects a cable that has become disconnected and then resets the apparatus.

In the event of a YES result in block 106 (indicating that a light pulse is expected) then method 100 returns to block 102. Otherwise, method 100 proceeds to block 125 where a bit is set in a bit string (FLAG3) and method 100 proceeds to block 126. In block 126, the bit string FLAG3 is compared to a predetermined pattern, PATTERN3, that would be expected for the cases where there is light leaking to light detector 14, patch 27 is loose, light detector 14 is not shielded from ambient light, or patch 27 has been removed from a subject. If block 126 returns a NO result then method 100 returns to block 102.

If block 126 returns a YES result then method 100 inhibits light emitters 20 in block 128, and generates a message (such as a display, warning light, sound, etc.) indicating to users what has occurred in block 129. In block 130 method 100 places the apparatus in the auto-recovery mode (including inhibiting operation of light emitters 20). Method 100 then returns to block 102.

Certain implementations of the invention comprise computer processors which execute software instructions which cause the processors to perform a method of the invention. For example, one or more processors in a light-emitting device may implement the methods of FIGS. 5 and 6 by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many modifications, permutations, additions and sub-combinations are possible in the practice of this invention without departing from the spirit or scope thereof. For example:
Electronic circuit 70 may include a programmable device such as a data processor, may be provided on an application specific integrated circuit (ASIC), may comprise a suitably-configured field programmable gate array (FPGA), may be made with discrete components or a combination of integrated circuits and discrete components, or the like.
   It is therefore intended that the following appended claims and claims hereafter introduced are interpreted to include all such modifications, permutations, additions and sub-combinations as are within their true spirit and scope.

1. An apparatus for guarding against unintended exposure to light from a light-emitting device, the light-emitting device operable to direct light to a subject for detection by a light detector, the apparatus comprising:
a test point for sampling a sensor signal within a time interval, the sensor signal indicative of intensity of light detected by the light detector; and
a circuit configured to:
receive a value for the sampled sensor signal from the test point;
determine whether emitted light is expected from the light-emitting device within the time interval;
compare the sampled sensor signal value to a threshold value; and
generate an inhibition signal to inhibit emission of light from the light-emitting device based at least in part on the determination of whether emitted light is expected and the comparison of the sampled sensor signal value to the threshold value.

2. An apparatus according to claim 1, wherein the circuit is configured to generate the inhibition signal if the sampled sensor signal value is above the threshold value and no emitted light is expected from the light-emitting device within the time interval.

3. An apparatus according to claim 1, wherein the circuit is configured to generate the inhibition signal if the sampled sensor signal value is below the threshold value and emitted light is expected from the light-emitting device within the time interval.

4. An apparatus according to claim 1, wherein the circuit is configured to generate an operation signal to operate the light-emitting device in normal mode if the sampled sensor signal value is below the threshold value and no emitted light is expected from the light-emitting device within the time interval.

5. An apparatus according to claim 1, wherein the light-emitting device emits light pulses and the test point is configured to sample the sensor signal at periodic intervals that are spaced apart by times that are shorter than or equal to a duration of each light pulse.

6. An apparatus according to claim 5, wherein the circuit is configured to:
detect continuous wave operation of the light-emitting device; and
generate the inhibition signal if the light-emitting device is operating in continuous wave operation.

7. An apparatus according to claim 5, wherein the circuit is configured to:
store values of the sampled sensor signal;
identify a pattern in the stored sampled sensor signal values; and
generate the inhibition signal based at least in part on the identified pattern.

8. An apparatus according to claim 6, wherein the circuit is configured to detect continuous wave operation of the light-emitting device by monitoring the sampled sensor signals for an absence of sampled sensor signals having a value below the threshold value.

9. An apparatus according to claim 1, wherein the circuit is configured to determine whether emitted light is expected from the light-emitting device within the time interval by one or more of the following:
detecting electrical current supplied to a light emitter of the light-emitting device;
querying a control setting of the light-emitting device; and
monitoring a system clock.

10. An apparatus according to claim 1, wherein the circuit is configured to identify a pattern in the values of the sampled sensor signal and to compare the identified pattern to predetermined patterns, the predetermined patterns being indicative of at least one of:
ambient light is received by the light detector;
the light detector is shielded from ambient light;
a patch containing the light detector is properly attached to the subject;
a patch containing the light detector is loose or detached from the subject;
broken or disconnected optical fibers in the light-emitting device;
broken or disconnected receiver cables in the light detector;
malfunctioning light emitters in the light-emitting device; and
light leaking from the light-emitting device and detected by the light detector.

11.-13. (canceled)

14. An apparatus according to claim 10, wherein the circuit is configured to generate the inhibition signal based at least in part on the comparison of the identified pattern to one or more of the predetermined patterns.

15. An apparatus according to claim 14, wherein the circuit is configured to generate the operation signal based at least in part on the comparison of the identified pattern to one or more of the predetermined patterns.

16. (canceled)

17. An apparatus according to claim 1, comprising an alarm which is activated by the circuit if the inhibition signal is generated by the circuit.

18.-19. (canceled)

20. An apparatus according to claim 1, wherein the circuit is configured to:
compare the sampled sensor signal value to a second threshold value; and
generate the inhibition signal if the sampled sensor signal value is above the second threshold value.

21. An apparatus according to claim 1, comprising a second test point for sampling a second sensor signal indicative of intensity of light detected by a second light detector, the second light detector positioned to detect light from the light-emitting device prior to the light passing through tissues of the subject, wherein the circuit is configured to:
receive a value for the second sampled sensor signal from the second test point;
compare the second sampled sensor signal value to a second threshold value; and
generate the inhibition signal if the second sampled sensor signal value is above the second threshold value.

22. An apparatus according to claim 6, wherein the circuit comprises monitoring means to monitor electrical current supplied to a light emitter of the light-emitting device, and wherein the circuit is configured to detect continuous wave operation of the light-emitting device based at least in part on the monitored electrical current.

23. An apparatus according to claim 22, wherein the monitoring means comprises a resistor connected in series with the light emitter, and circuit elements configured to measure a voltage drop across the resistor wherein the circuit elements are configured to integrate the measured voltage drop.

24.-25. (canceled)

26. An apparatus according to claim 22, wherein the circuit elements are configured to integrate the measured voltage drop over an integral number of periods of a driving signal of the light emitter.

27. An apparatus according to claim 22, wherein the monitoring means comprises circuit elements configured to detect pulses in a driving signal of the light emitter, and a timer configured to time the detected pulses.

28. An apparatus according to claim 1, comprising a mechanical interlock for preventing unintended exposure to light from a port of the light-emitting device, the mechanical interlock comprising a guard moveable between a closed position to cover the port and an open position to expose the port.

29. An apparatus according to claim 28, wherein the mechanical interlock comprises a switch moveable between an ON position for activating a power supply of the light-emitting device and an OFF position for deactivating the power supply of the light-emitting device, the switch located such that it blockingly engages with the guard to prevent movement of the guard to the open position when the guard is in the closed position and the switch is in the ON position.

30. An apparatus according to claim 28, wherein the mechanical interlock comprises a switch moveable between an ON position for activating a power supply of the light-emitting device and an OFF position for deactivating the power supply of the light-emitting device, the switch located such that when the switch is in the ON position and the guard is in the closed position, the guard engages with and moves the switch to the OFF position if the guard is moved from the closed position to the open position.

31.-32. (canceled)

33. An apparatus according to claim 28, wherein the guard defines an opening for passage of cables therethrough, the opening located away from a direct line of sight to the port.

34. An apparatus according to claim 28, wherein the guard is positioned to leave a gap between the guard and the light-emitting device for passage of cables therethrough, the gap located away from a direct line of sight to the port.

35.-37. (canceled)

38. An apparatus according to claim 28, wherein the circuit is configured to:
detect whether a cable is connected to the port; and
generate the inhibition signal if the cable is disconnected from the port.

39. An apparatus according to claim 28, wherein the circuit is configured to:
detect whether the guard is in the open position; and
generate the inhibition signal if the guard is in the open position.

40. An apparatus for guarding against unintended exposure to light from a light-emitting device, the light-emitting device operable to direct light to a subject for detection by a light detector, the apparatus comprising:
a test point for periodically sampling a sensor signal, the sensor signal indicative of intensity of light detected by the light detector; and
a control circuit configured to:
receive values for the sampled sensor signal from the test point;
compare each sampled sensor signal value to a threshold value;
determine whether emitted light is expected from the light-emitting device at a time of sampling the sensor signal;
set a flag for each sampled sensor signal value based at least in part on the comparison with the threshold value and the determination of whether emitted light is expected;
identify a pattern in the flags set for the sampled sensor signal values;
compare the identified pattern with a predetermined pattern indicative of one or more of:
ambient light is received by the light detector;
a patch containing the light detector is loose or detached from the subject; and
light leaking from the light-emitting device and detected by the light detector; and
generate an inhibition signal to inhibit emission of light from the light-emitting device if the identified pattern matches the predetermined pattern.

41. An apparatus according to claim 40, comprising monitoring means for detecting continuous wave operation of the light-emitting device, the monitoring means comprising:
a resistor connected in series with a light emitter of the light-emitting device;
an amplifier connected to detect a signal indicative of a voltage drop across the resistor; and
a low pass filter through which the signal indicative of the voltage drop is passed to provide an output,
wherein the control circuit is configured to compare the output to a second threshold value and to generate the inhibition signal if the output is above the second threshold value.

42.-46. (canceled)

47. An apparatus according to claim 40 operable as a near-infrared spectroscopy system, the apparatus comprising:
a light detector located on a patch; and
an optical fiber for carrying light emitted by the near-infrared light-emitting device to the patch.

48. Apparatus according to claim 47, wherein the light detector located on the patch comprises a receiver cable for carrying detected light to one or more sensors.

49. Apparatus according to claim 40, comprising an optical fiber for carrying near-infrared light emitted by the light-emitting device to a location on a catheter.

50. (canceled)

51. Apparatus according to claim 40, comprising a guard moveable between a closed position and an open position, wherein, when the guard is in the closed position the guard covers a port and prevents detachment of an optical fiber from the port, and when the guard is in the open position, the port is exposed.

52. Apparatus according to claim 51, comprising a switch moveable between an ON position for activating a power supply of the light-emitting device and an OFF position for deactivating the power supply of the light-emitting device, the switch located such that it blockingly engages with the guard to prevent movement of the guard to the open position when the guard is in the closed position and the switch is in the ON position.

53.-54. (canceled)

55. Apparatus according to claim 51, wherein a portion of the guard is opaque to prevent direct viewing of the port when the guard is in the closed position.

56. Apparatus according to claim 40, comprising a continuous wave safety mechanism for monitoring continuous wave operation of the light-emitting device and generating an inhibition signal to inhibit emission of light if continuous wave operation is detected.

57. Apparatus according to claim 56, wherein the continuous wave safety mechanism comprises:
sensor means to detect light emitted by the light-emitting device before or after the emitted light passes through tissues of a subject.

58. Apparatus according to claim 56, wherein the continuous wave safety mechanism comprises means to monitor electrical current supplied to a light emitter of the light-emitting device.

59. Apparatus according to claim 44, comprising control means to generate an inhibition signal if emitted light is expected from the light-emitting device and a signal detected by a sensor is below a threshold.

60.-100. (canceled)

101. An apparatus for guarding against unintended exposure to light from a light-emitting device, the light-emitting device operable to direct light to a subject for detection by a light detector, the apparatus comprising:
a test point for sampling a sensor signal, the sensor signal indicative of intensity of light detected by the light detector; and
a circuit configured to:
compare the sampled sensor signal value to a threshold value; and
generate an inhibition signal to inhibit emission of light from the light-emitting device if the sampled sensor signal value is above the threshold value.

102. An apparatus for guarding against unintended exposure to light from a light-emitting device, the light-emitting device operable to direct light to a subject for detection by a light detector, the apparatus comprising:
a test point for sampling a sensor signal, the sensor signal indicative of intensity of light detected by a second light detector, the second light detector positioned to detect light from the light-emitting device prior to the light passing through tissues of the subject; and
a circuit configured to:
compare the sampled sensor signal value to a threshold value; and
generate an inhibition signal to inhibit emission of light from the light-emitting device if the sampled sensor signal value is above the threshold value.

103. An apparatus according to claim 101, wherein the light-emitting device emits light pulses, and the circuit is configured to:
detect continuous wave operation of the light-emitting device; and
generate the inhibition signal if the light-emitting device is operating in continuous wave operation.

104. An apparatus according to claim 103, wherein the circuit comprises monitoring means to monitor electrical current supplied to a light emitter of the light-emitting device, and wherein the circuit is configured to detect continuous wave operation of the light-emitting device based at least in part on the monitored electrical current.

105. An apparatus according to claim 104, wherein the monitoring means comprises a resistor connected in series with the light emitter, and circuit elements configured to measure a voltage drop across the resistor.

106. An apparatus according to claim 105, wherein the circuit elements comprise:
an amplifier connected to detect a signal indicative of the voltage drop across the resistor; and
a low pass filter through which the signal indicative of the voltage drop is passed.

107. An apparatus according to claim 105, wherein the circuit elements are configured to integrate the measured voltage drop over an integral number of periods of a driving signal of the light emitter.

108. An apparatus according to claim 104, wherein the monitoring means comprises circuit elements configured to detect pulses in a driving signal of the light emitter, and a timer configured to time the detected pulses.

109. An apparatus for guarding against unintended exposure to light from a light-emitting device, the light-emitting device operable to direct light to a subject for detection by a light detector, the apparatus comprising:
a mechanical interlock for preventing unintended exposure to light from a port of the light-emitting device, the mechanical interlock comprising a guard moveable between a closed position to cover the port and an open position to expose the port wherein the mechanical interlock comprises a switch moveable between an ON position for activating a power supply of the light-emitting device and an OFF position for deactivating the power supply of the light-emitting device, the switch located such that it blockingly engages with the guard to prevent movement of the guard to the open position when the guard is in the closed position and the switch is in the ON position.

110.-113. (canceled)

114. An apparatus according to claim 109, wherein the guard defines an opening for passage of cables therethrough, the opening located away from a direct line of sight to the port.

115. An apparatus according to claim 109, wherein the guard is positioned to leave a gap between the guard and the light-emitting device for passage of cables therethrough, the gap located away from a direct line of sight to the port.

116.-118. (canceled)

119. An apparatus according to claim 109, comprising a circuit configured to:
detect whether the guard is in the open position; and
generate an inhibition signal to inhibit emission of light from the light-emitting device if the guard is in the open position.

120. An apparatus according to claim 119, wherein the circuit is configured to:
detect whether a cable is connected to the port; and
generate the inhibition signal if the cable is disconnected from the port.
